(19) United States
(12) Patent Application Publication
(10) Pub. No.: US 2025/0124584 A1
(43) Pub. Date: Apr. 17, 2025

(54) METHOD FOR TESTING INDICATOR LIGHT AND ELECTRONIC DEVICE

(71) Applicant: Fulian Precision Electronics (Tainjin) Co., LTD., Tianjin (CN)

(72) Inventors: TENG-FEI MA, Tianjin (CN); Jie Yuan, Tianjin (CN)

(21) Appl. No.: 18/520,122

(22) Filed: Nov. 27, 2023

(30) Foreign Application Priority Data
Oct. 12, 2023 (CN) 202311324462.4

(51) Int. Cl. G06T 7/246; G06T 7/80

(52) U.S. Cl. CPC G06T 7/246; G06T 7/80; G06T 2207/10016; G06T 2207/30232

(57) ABSTRACT

A method for testing indicator light and an electronic device are provided. The method comprising: receiving a surveillance video of an indicator light; determining a target location of the indicator light in each frame image of the surveillance video according to a template image, and the template image comprising location mark of the indicator light; obtaining image information of the indicator light at the target location according to the location mark; determining a flashing frequency and a duty cycle of the indicator light according to the image information; determining a working status of the indicator light according to the flashing frequency and the duty cycle. The present application is able to use a camera in any position to monitor the working status of the indicator light from any angle, and locate multiple irregular position indicator light in advance before testing the indicator light, thereby improving a testing efficiency.

This application claims priority to Chinese Patent Application No. 202311324462.4 filed on Oct. 12, 2023, in China National Intellectual Property Administration, the contents of which are incorporated by reference herein.

### FIELD

The subject matter herein generally relates to an equipment testing technology field, in particular, relates to a method for testing indicator light and an electronic device.

### BACKGROUND

Currently, there are many indicator lights on an electronic equipment to indicate working status of the electronic equipment. Before testing the electronic equipment, it is necessary to test the working status of the indicator lights to confirm whether a function of the indicator lights is normal. Therefore, the working status of the electronic device can be confirmed based on the working status of the indicator light. However, since the number of the indicator lights and location of the indicator lights on different electronic devices are different, and distribution positions of the indicator lights on the electronic devices may be irregular, manual visual inspection is usually used to detect the working status of the indicator lights. However, the above manual testing method of testing the indicator light is inefficient.

### BRIEF DESCRIPTION OF THE DRAWINGS

Implementations of the present application will now be described, by way of embodiment, with reference to the attached figures.

FIG. 1 shows an operating environment of a method for testing indicator light provided by the present application.

FIG. 2 is a flowchart of the method for testing indicator light provided by the present application.

FIG. 3 is a schematic diagram of transmitting a template image including a position mark provided by an embodiment of the present application.

FIG. 4 is a schematic diagram of determining a starting frame in a surveillance video provided by an embodiment of the present application.

FIG. 5 is a schematic diagram of determining a flashing period of an indicator light according to an embodiment of the present application.

FIG. 6 is a flowchart of obtaining a template image provided by an embodiment of the present application.

FIG. 7 is a flowchart of obtaining a target location provided by an embodiment of the present application.

FIG. 8 is a flowchart of obtaining a target location provided by another embodiment of the present application.

FIG. 9 is a functional module diagram of a device for testing indicator light provided by the present application.

FIG. 10 is a structural diagram of one embodiment of the method for testing indicator light.

### DETAILED DESCRIPTION

In order to understand the purpose, features and advantages of the present application more clearly, the present application will be described in detail below in conjunction with the accompanying drawings and specific embodiments. It should be noted that, as long as there is no conflict, the embodiments of the present application and the features in the embodiments can be combined with each other. Many specific details are set forth in the following description to facilitate a full understanding of the present application. The described embodiments are only a part of the embodiments of the present application, rather than all of the embodiments.

In addition, the terms “first” and “second” are used for descriptive purposes only and cannot be understood as indicating or implying relative importance or implicitly indicating the quantity of indicated technical features. Therefore, features defined as “first” and “second” may explicitly or implicitly include one or more of the described features. In the description of the application, “plurality” means two or more than two, unless otherwise explicitly and specifically limited.

Unless otherwise defined, all technical and scientific terms used herein have the same meaning as commonly understood by one of ordinary skill in the technical field to which the application belongs. The terminology used herein in the description of the application is for the purpose of describing specific embodiments only and is not intended to limit the application. As used herein, the term “and/or” includes any and all combinations of one or more of the associated listed items.

The embodiments of the present application provide a method for testing indicator light, and the method can be applied to one or more electronic devices. In one embodiment, the electronic device is a device that can automatically perform calculation of parameter value and/or information processing according to pre-set or stored instructions. In one embodiment, hardware of the electronic device includes, but is not limited to a microprocessor, an Application Specific Integrated Circuit (ASIC), a Field-Programmable Gate Array (FPGA), a Digital Signal Processor (DSP), or an embedded device, etc.

In one embodiment, the electronic device can be any electronic product that can interact with a user, such as a personal computer, a tablet computer, a smart phone, a Personal Digital Assistant (PDA), a game console, and an Internet Protocol Television (IPTV), a smart wearable device, etc.

In one embodiment, the electronic device may also include a network equipment and/or a user equipment. In one embodiment, the network device includes, but is not limited to, a single network server, a server group consisting of multiple network servers, or a cloud computing-based cloud consisting of a large number of hosts or network servers.

In one embodiment, a network connected to the electronic device includes, but is not limited to, the Internet, a wide area network, a metropolitan area network, a local area network, and a Virtual Private Network (VPN).

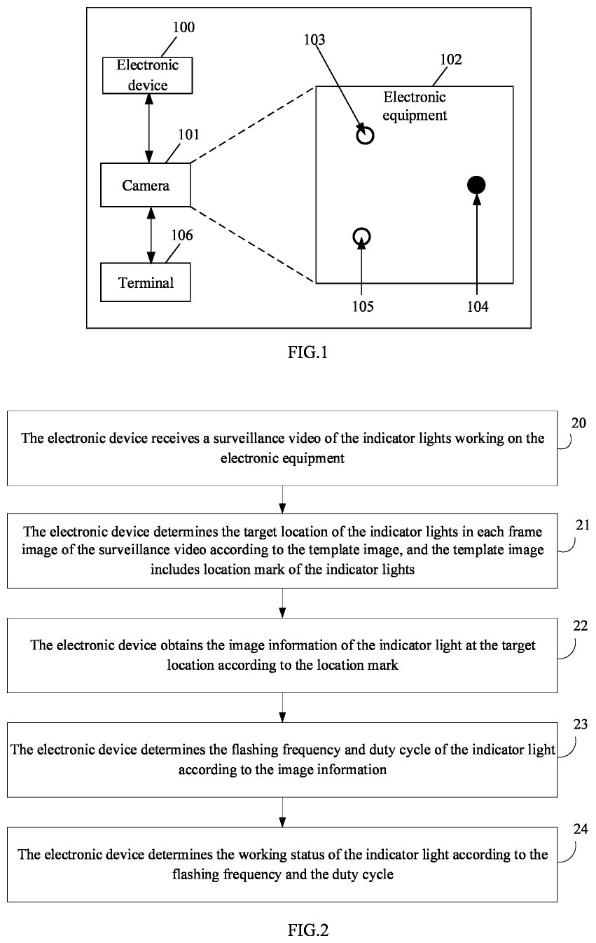

As shown in FIG. 1, the method for testing indicator light provided by the application can be applied to electronic device 100. The electronic device 100 is connected to a camera 101. The camera 101 is used to monitor an electronic equipment 102 equipped with an indicator light. The electronic equipment 102 includes at least one indicator light. In the embodiment of the present application, the number of indicator lights is three, such as the indicator light 103, the indicator light 104 and the indicator light 105 in FIG. 1. The white circles in FIG. 1 represent the indicator light 103 and the indicator light 105, and the white circles indicate that the indicator light 103 and the indicator light 105 are in a lighted status. The black circle in FIG. 1 represents the indicator light 104, which is used to indicate that the indicator light 104 is in an extinguished status. In one embodiment, before confirming the working status of the electronic equipment 102 through the working status of the indicator light 103, the indicator light 104 and the indicator light 105, it is necessary to first test whether the indicator light 103, the indicator light 104 and the indicator light 105 can operate normally during a working process of the electronic equipment 102. In one embodiment of the present application, the camera 101 monitors the indicator lights in the electronic equipment 102 in real time, and obtains a surveillance video, and sends the surveillance video to the electronic device 100. Then, the electronic device 100 determines the target location of the indicator lights in each frame of the surveillance video according to at least one pre-stored template image, and determines the working status of the indicator lights in the electronic equipment 102 according to the image information at location marks of the target location. In one embodiment, the at least one template image includes location markers of the indicator lights.

It should be noted that, after obtaining the template image with the location markers, the electronic device 100 also sends the template image to a terminal 106 to facilitate the staff to calibrate the location markers in the template image through the terminal 106.

FIG. 2 illustrates a flowchart of the method for testing indicator light. According to different needs, an order of steps in the flowchart can be changed and some steps can be omitted.

At block 20, the electronic device receives a surveillance video of the indicator lights working on the electronic equipment.

In one embodiment of the present application, before receiving the surveillance video, the electronic device sends a control instruction to the electronic equipment, and controls the electronic equipment to operate, and enables the indicator lights on the electronic device enters the working status.

In one embodiment of the present application, the electronic equipment including the indicator lights is monitored in real time by the camera, and the surveillance video of the indicator lights working on the electronic equipment is obtained in real time. In one embodiment, the lighted status and the extinguished status of the indicator light represents different working status of the electronic equipment. For example, when the electronic equipment is a transformer with a power indicator light, when the power indicator light is in the lighted status, it means that the transformer is powered on, and when the power indicator light is in the extinguished status, it means that the transformer is not powered on. For another example, the electronic equipment is a computer motherboard equipped with a self-test indicator of a central processing unit (CPU). When the self-test indicator light flashes at a preset frequency, it indicates that the CPU in the computer motherboard is self-checking. When the self-test indicator light goes out, it indicates that the CPU in the computer motherboard is not self-checking.

In this way, by monitoring the electronic equipment including the indicator light in real time and continuously observing the working status of the indicator lights on the electronic equipment, data support can be provided for subsequent evaluation of the working status of the indicator lights.

At block 21, the electronic device determines the target location of the indicator lights in each frame image of the surveillance video according to the template image, and the template image includes location mark of the indicator lights.

In one embodiment of the present application, before evaluating the working status of the indicator lights, the target location of the indicator light in each frame image of the surveillance video can be determined according to the template image. In this way, during a subsequent analysis process of the working status of the indicator light, the working status of the indicator lights can be obtained by analyzing the image information at the target location in each frame image. There is no need to analyze all the image information in each frame image, thus improving an efficiency of testing the indicator light.

In one embodiment of the present application, obtaining the location mark of the indicator lights includes: obtaining a pixel value of each pixel in a pre-stored target image; when the pixel value is within a preset pixel value range, determining the pixel point coordinates corresponding to the pixel values in the target image as the target location; recording the location mark in the target image by the target location to obtain the template image.

In one embodiment, the target image may be any video frame in the surveillance video collected by the camera, or may be a single surveillance image obtained by photographing the electronic device by the camera before obtaining the surveillance video. This application does not limit the form of the target image.

In one embodiment, an image recognition model is used to identify the indicator lights in the target image. An input of the image recognition model is the target image. An output of the image recognition model is an image with multiple candidate detection frames, and each candidate frame corresponds to a confidence level. The confidence level of one candidate detection frame is used to characterize a probability value that the pixels in the candidate detection frame is one indicator light. In one embodiment, the image recognition model can be a FOMO model.

In one embodiment, when the confidence level of one candidate detection frame is 99%, the probability value that the pixels in the candidate detection frame are indicators is 99%.

In one embodiment, when the confidence level of the candidate detection frame is greater than a preset confidence level, it indicates that the pixels in the candidate detection frame are pixels of one indicator light, and then a location of the candidate detection frame in the target image can be determined to be the target location of the indicator light. In one embodiment, when the detection frame includes 1 pixel, the target position is the coordinate of the pixel in the target image; when the detection frame includes multiple pixels, the target location is the coordinates of all pixels in the candidate detection frame.

For example, when the preset confidence level is 85%, and the confidence level of the candidate detection frame is 90%, the location of the candidate detection frame in the target image is the target location of the indicator light.

In one embodiment of the present application, the template image is obtained by recording the location mark in the target image by the target location.

In this way, the target location of the indicator light in the target image is identified, and then the position mark of the indicator light is determined according to the target position, so that in subsequent testing process of the indicator light, the target location of the indicator light in each frame of the image can be determined by the location mark, and the image information at the target location can be analyzed, which can improve a testing efficiency of the indicator light.

In one embodiment of the present application, after recording the location mark in the target image by the target location and obtaining the template image, the method further includes: sending the template image including the location mark to the terminal communicated with the electronic device; receiving position calibration confirmation information sent by the terminal; when the position calibration confirmation information indicates that a calibration has passed, receiving a monitoring video of the indicator light on the electronic equipment.

In one embodiment, in order to calibrate the location mark in the template image to ensure that the location mark in the template image can accurately represent the location of the indicator light, the template image including the location mark can be transmitted to a terminal that is communicatively connected to the electronic device, therefore, the template position mark can be calibrated. In one embodiment, the terminal can be a host computer, a mobile phone, a tablet computer, etc., which is not limited in the application.

In one embodiment, the template image including the position mark can be transmitted by using a wired transmission method or a wireless transmission method. In one embodiment, the wireless transmission method includes a Bluetooth transmission, and the wired transmission method includes a I2C port transmission and a URAT port transmission.

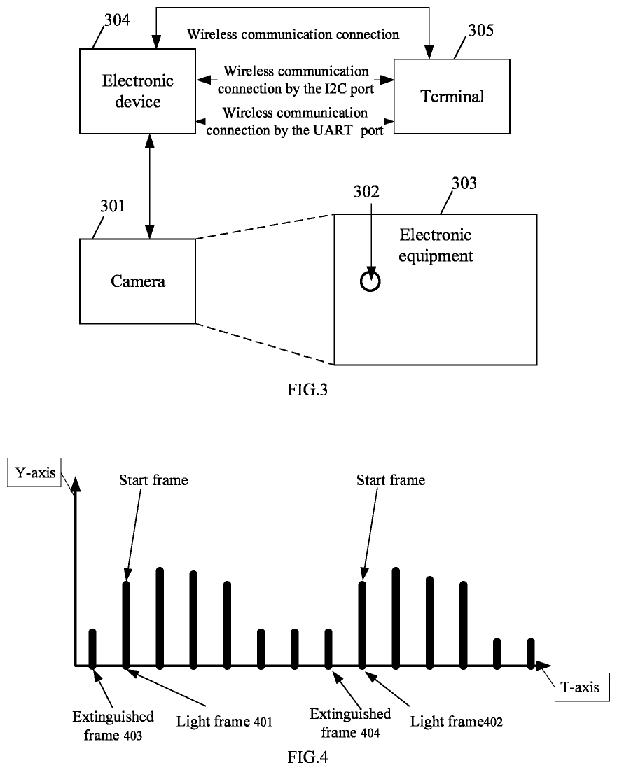

As shown in FIG. 3, a camera 301 monitors the electronic equipment 303 equipped with the indicator light 302 in real time, and obtains the location mark of the indicator light 302 in the template image. The electronic device 304 communicates with the camera 301 to obtain the template image with the position mark of the indicator light 302 collected by the camera 301. The terminal 305 performs a wireless communication connection with the electronic device 304 by a wireless transmission module (not shown), or performs a wired communication connection with the electronic device 304 by the I2C port or UART port. The electronic device 304 transmits the template image including the location mark of the indicator light 302 collected by the camera 301 to the terminal 305. The staff can check the location mark of the indicator light in the template image by the terminal 305. When the staff determines that the location mark of the indicator light 302 is accurate, the testing process of the indicator light testing can continue.

In one embodiment of the present application, the method further includes: when the position calibration confirmation information indicates that the calibration has not passed, repositioning the indicator light in the target image.

As shown in FIG. 3, when determining that the location mark of the indicator light 302 is inaccurate, the electronic device 304 may repeatedly perform blocks 20 to 21 to reposition the location mark of the indicator light 302 in the template image.

In one embodiment of the present application, after the electronic device obtains the target location of the indicator light within an imaging range, the device including the indicator light receives an operating instruction sent by a host computer and enters the working status according to the operating instruction, at this time, the indicator light starts flashing. In one embodiment, each of operating instructions corresponds to a standard status of the indicator light, that is, when the device including the indicator light operates according to different operating instructions, the indicator light has different flashing frequencies and duty cycles. The duty cycle refers to a ratio of a lighting time of the indicator light to a preset period within a preset period.

At block 22, the electronic device obtains the image information of the indicator light at the target location according to the location mark.

In one embodiment of the present application, in order to determine the working status of the indicator light, the image information of the indicator light at the target location can be determined according to the location mark, and the working status of the indicator light can be determined according to the changes in the image information. The image information at least includes brightness values of the pixels at the target location.

For example, when the brightness values at the target location are more than or equal to a default value, it indicates that the indicator light is in the lighted status, and when the brightness values at the target position is less than the default value, it indicates that the indicator light is in the extinguished status. In one embodiment, the working status of the indicator light can be determined based on the number and frequency of transitions between the lighted status and the extinguished status of the indicator light.

At block 23, the electronic device determines the flashing frequency and duty cycle of the indicator light according to the image information.

In one embodiment of the present application, in order to test the working status of the indicator light, operating parameters of the indicator light can be determined according to the image information. The image information includes the brightness value at the target location in each frame of the surveillance video. The operating parameters of the indicator light include at least the flashing frequency and the duty cycle.

In one embodiment of the present application, the duty cycle is a ratio of a time that the indicator light is in the lighted status per unit time in the surveillance video to the unit time. For example, when the unit time is 10 seconds and a total time that the indicator light is in the lighted status within 10 seconds of the surveillance video is 5 seconds, the duty cycle of the indicator light is 0.5.

In an embodiment of the present application, the surveillance video includes multiple video frames. In one embodiment, determining the flashing frequency and duty cycle of the indicator light includes: obtaining the brightness values at the target location in each of the video frames, each of the video frames corresponds to a timestamp; determining the flashing frequency and duty cycle of the indicator light according to the brightness values and the timestamp.

In one embodiment, the surveillance video refers to the surveillance video of the indicator light collected by the camera within a preset time period. The surveillance video includes multiple video frames, and each video frame is used to represent image information within the imaging range of the camera, and each video frame corresponds to a timestamp. And the timestamp is used to characterize a moment when the video frame was collected.

In one embodiment, the image information at the target location in the video frame is the image information of the indicator light within the imaging range of the camera. For the target location in each video frame, when the brightness value at the target location is within a preset brightness value range, the indicator light lights up. When the brightness value at the target location is not within the preset brightness value range, it means the indicator light is off. In one embodiment, when the target position includes one pixel, the brightness value of the pixel is used as the brightness value of the target location; when the target location includes multiple pixels, an average of the brightness values of the multiple pixels is used as the brightness value of the target location.

In one embodiment of the present application, when the brightness value at the target location in a certain video frame is greater than the brightness value at the target location in the previous frame corresponding to the certain video frame, and a brightness value difference is greater than a preset threshold, the video frame is marked as a start frame; when the brightness value at the target location in a certain video frame is greater than the brightness value at the target location in a following frame corresponding to the certain video frame, and the brightness value difference is greater than the preset threshold, the video frame is marked as a termination frame. When a difference between the brightness value at the target location in a certain video frame and the brightness value at the target location in any start frame or any termination frame is less than or equal to the preset threshold, the video frame is determined to be a light frame; when the difference between the brightness value at the target location in the certain video frame and the brightness value at the target location in any start frame or any termination frame is greater than the preset threshold, the video frame is determined to be an extinguished frame.

In one embodiment of the present application, a flashing period of the indicator light is calculated according to the timestamps of any two adjacent start frames, and the flashing frequency of the indicator light is determined according to the flashing period.

As shown in FIG. 4, a T-axis is used to characterize a time axis of the surveillance video, and a Y-axis is used to characterize ta brightness value at the target location of each video frame in the surveillance video. In one embodiment, the surveillance video includes a light frame 401 and a light frame 402, as well as an extinguished frame 403 and an extinguished frame 404. Since the previous video frame of the light frame 401 is the extinguished frame 403, the light frame 401 is marked as the start frame. For another example, the previous video frame of the light frame 402 is the light frame 404, so the light frame 402 is marked as the start frame.

In one embodiment, since the start frame represents the transition of the indicator light from the extinguished status to the light status, the flashing cycle of the indicator light can be determined according to the timestamps corresponding to any two adjacent start frames. At the beginning of the flashing cycle, the indicator light switches from the extinguished status to the light status, and then switches from the light status to the extinguished status for a period of time. At the end of the flashing cycle, the indicator light switches from the extinguished status to the light status again to enter a next flashing cycle.

As shown in FIG. 5, the T-axis is used to represent the time axis of the surveillance video, and the Y-axis is used to represent the brightness value at the target location of each video frame in the surveillance video. In one embodiment, the start frame 501 and the start frame 502 are two adjacent start frames, and the timestamp corresponding to the start frame 501 is timestamp 503, the timestamp corresponding to the start frame 502 is timestamp 504, and the time difference between the timestamp 503 and the timestamp 504 is one flashing period of the indicator light 505.

In one embodiment, after obtaining the flashing period of the indicator light, a unit of the flashing period can be converted into seconds, and the ratio of 1 second to the flashing period can be calculated to obtain the flashing frequency of the indicator light. The flashing frequency is used to represent the number of times the indicator light flashes within 1 second.

For example, when a flashing period of the indicator light is 0.08 seconds, the flashing frequency of the indicator light is calculated according to a formula: Freq=1/0.08=12.5 Hz, Freq is the flashing frequency.

In one embodiment, determining the duty cycle of the indicator light according to the brightness value and the timestamp includes: calculating a ratio of the number of the light frames to the total number of all video frames in the surveillance video, and obtain the duty cycle of the indicator light.

In one embodiment, the duty cycle is the ratio of the length of time that the indicator light is on in the unit time in the surveillance video to the unit time.

For example, when the number of the light frames is 8 and the surveillance video includes a total of 14 video frames, the duty cycle of the indicator light is calculated according to a formula: Ratio=8/14=0.57.

By analyzing the image information in the surveillance video, the flashing frequency and duty cycle of the indicator light are obtained, thus avoiding the problem of low testing efficiency when manually testing the indicator light visually.

At block 24, the electronic device determines the working status of the indicator light according to the flashing frequency and the duty cycle.

In one embodiment of the present application, the flashing frequency and duty cycle of the indicator light can characterize the working status of the indicator light. When the flashing frequency and duty cycle of the indicator light satisfy a certain preset condition, it indicates that the indicator light is working normally.

In one embodiment of the present application, determining the working status of the indicator light according to the flashing frequency and the duty cycle includes: when the flashing frequency satisfying a first condition, and the duty cycle satisfies the second condition, determining that the indicator light is in a normal working condition. The first condition includes that an absolute error between the flashing frequency and the preset flashing frequency does not exceed a preset first difference, and the second condition includes that an absolute error between the duty cycle and the preset duty cycle does not exceed a preset second difference.

In one embodiment, the preset flashing frequency and the preset duty cycle refer to the flashing frequency and duty cycle that the indicator light should have after the electronic equipment receives a control instruction sent by the electronic device and starts running. The preset flashing frequency and the preset duty cycle corresponds to the control instruction sent by the electronic device.

For example, the electronic device sends a control instruction A to the electronic equipment to control the indicator light of the electronic equipment to enter a working status. When the preset flashing frequency corresponding to the control instruction A is 12.8 Hz and the preset duty cycle is 0.5, and when the flashing frequency of the indicator light is 12.5 Hz and the duty cycle is 0.57, and when the preset first difference value is 1 Hz and the preset second difference value is 0.1, since the flashing frequency of the indicator light satisfies the first condition, and the duty cycle of the indicator light satisfies the second condition, the working status of the indicator light is normal.

For another example, the electronic device sends a control instruction B to the electronic equipment to control the indicator light in the electronic equipment to enter a working status. When the preset flashing frequency corresponding to the control instruction B is 12.8 Hz and the preset duty cycle is 0.5, when the flashing frequency of the indicator light is 13.8 Hz and the duty cycle is 0.67, and when the preset first difference value is 1 Hz and the preset second difference value is 0.1, the flashing frequency of the indicator light does not satisfy the first condition and the duty cycle of the indicator light does not satisfy the second condition. Therefore, the working status of the indicator light is abnormal.

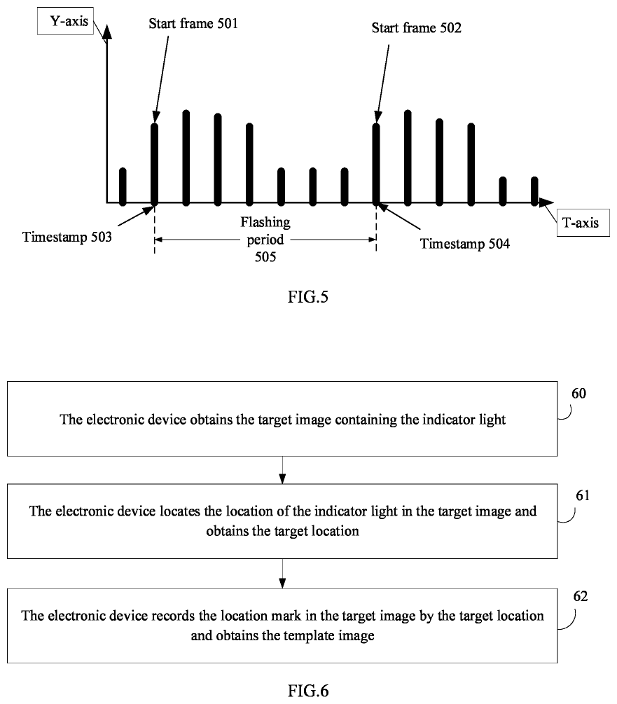

FIG. 6 illustrates a flowchart of obtaining a template image provided by an embodiment of the present application. A process of obtaining template image shown in FIG. 6 specifically includes as follow steps.

At block 60, the electronic device obtains the target image including the indicator light.

In one embodiment, the target image may be any video frame in the surveillance video collected by the camera, or may be a single surveillance image obtained by photographing the electronic equipment through the camera before obtaining the surveillance video, which are not limited in the present application.

At block 61, the electronic device locates the location of the indicator light in the target image and obtains the target location.

In one embodiment, the target location includes the coordinates of at least one pixel point, and each of the coordinates is used to represent the location of the indicator light within the imaging range of the camera.

At block 62, the electronic device records the location mark in the target image by the target location and obtains the template image.

In one embodiment, the location mark in the target image is recorded according to the target location to obtain the template image. The location mark in the template image is used to provide location information of the indicator light during a locating process.

For example, when the target location of the indicator light in the target image is (10, 10), then the location mark in the template image is also (10, 10); when the target location of the indicator light in the target image includes multiple coordinates, respectively (10, 10), (10, 11), (11, 10), (11, 11), then the location mark in the template image also includes multiple coordinates, respectively (10, 10), (10,11), (11,10), (11,11).

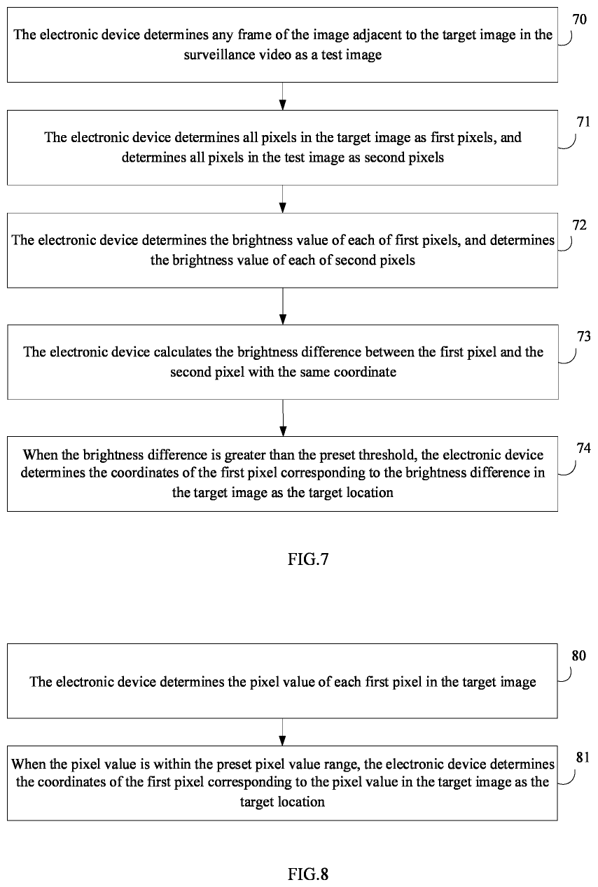

FIG. 7 illustrates a flowchart of obtaining a target location provided by an embodiment of the present application. The target image can be any frame image in the surveillance video, and a process of obtaining a target location as shown in FIG. 7 specifically includes as follow steps.

At block 70, the electronic device determines any frame of the image adjacent to the target image in the surveillance video as a test image.

In one embodiment of the present application, the indicator light changes from the extinguished status to the on status within a first preset time period when the device including the indicator light is powered on. Therefore, when the target image is any frame of the surveillance video, the target location of the indicator light in the target image can be obtained by identifying the area with a higher brightness change in the surveillance video. For example, the first preset time period may be 5 seconds.

In one embodiment of the present application, in order to determine the brightness change of each pixel in the surveillance video, first, any frame of the image adjacent to the target image in the surveillance video can be determined as the test image. The test image can be a next frame of the target image in the surveillance video, or it can be a previous frame of the target image in the surveillance video, which are not limited in the present application.

At block 71, the electronic device determines all pixels in the target image as first pixels, and determines all pixels in the test image as second pixels.

At block 72, the electronic device determines the brightness value of each of first pixels, and determines the brightness value of each of second pixels.

In one embodiment of the present application, since the target image and the test image are both digital images, the pixel value of each of first pixels and the second pixels has three channels, namely R channel, G channel and B channel. In order to obtain the brightness values of the first pixel and the second pixel, the values of the three channels can be converted into grayscale values to represent the brightness values of the first pixel or the second pixel. A method of converting the values of the R, G, and B channels into grayscale values satisfies the following relationship formula: gray=0.299*R+0.578*G+0.114*B, the gray represents a gray value of the first pixel or the second pixel, and its value range is (0, 255); R, G, and B respectively represent the R channel value, G channel value, and B channel value of the pixel, and the value range of the three channel values is (0, 255).

For example, when the pixel value of a first pixel in the target image includes R=100, G=50, and B=150, the grayscale value of the first pixel is calculated as:

$$gray = 0.299 * 100 + 0.578 * 50 + 0.114 * 150 = 7.59 .$$

In one embodiment of the present application, the grayscale value of a pixel can be used as the brightness value of the pixel.

At block 73, the electronic device calculates the brightness difference between the first pixel and the second pixel with the same coordinate.

In one embodiment of the present application, the brightness difference between the first pixel and the second pixel with the same coordinate can be calculated to represent the brightness change amount at the pixel point in the surveillance video.

For example, when the coordinates of a certain first pixel in the target image are 10th row 10 and 10th column, the coordinates of a certain second pixel in the test image are 10th row 10 and 10th column, and the brightness value of the first pixel is 75.9, and the brightness value of the second pixel is 254, then the brightness difference at 10th row 10 and 10th column is 178.1.

At block 74, when the brightness difference is greater than the preset threshold, the electronic device determines the coordinates of the first pixel corresponding to the brightness difference in the target image as the target location.

In one embodiment of the present application, when the brightness difference is greater than the preset threshold, it indicates that the brightness change amount at the coordinate is relatively high, and the coordinates of the first pixel corresponding to the brightness difference in the target image can be used as the target location of the indicator light in the target image.

For example, when the preset threshold is 100 and the pixel difference at 10th row and 10th column in the target image is 178.1, then the coordinates of the first pixel corresponding to the brightness difference in the target image are (10, 10), and the coordinates of the first pixel can be used to characterize the target location of the indicator light in the target image.

FIG. 8 illustrates a flowchart of obtaining a target location provided by another embodiment of the present application. The process of obtaining target location shown in FIG. 8 specifically includes follow steps.

At block 80, the electronic device determines the pixel value of each first pixel in the target image.

In one embodiment of the present application, since the target image is a digital image, the pixel value of each first pixel has three channels, namely R channel, G channel and B channel. Therefore, the pixel value of the first pixel may be in a three-dimensional vector format, for example, the pixel value of the first pixel may be [5, 200, 5].

At block 81, when the pixel value is within the preset pixel value range, the electronic device determines the coordinates of the first pixel corresponding to the pixel value in the target image as the target location.

In one embodiment, the indicator light may present different colors when it lights up, such as red, green, blue, etc. Therefore, the pixel value range can be preset according to the color of the indicator light, and then the pixel value of each pixel in the target image can be identified, and whether the pixel value is within the preset pixel value range can be determined. When the pixel value of the pixel is within the preset pixel value range, it indicates that the pixel value of the pixel is the same as the color of the indicator light. Further, the coordinates of the pixel in the target image can be marked as the target location of the indicator light.

For example, when the indicator light is green, the preset pixel value range may be:

$$[ 0 < R < 10 , 10 < G < 2 \; 56 , 0 < B < 10 ] .$$

In one embodiment of the present application, when the pixel value of a certain pixel is within a preset pixel value range, the coordinates of the pixel can be used as the target location of the indicator light in the target image. For example, when the pixel with coordinates (10, 10) corresponds to a pixel value of [R: 5, G: 200, B: 5], and the preset pixel value range is [0<R<10, 195<G<205, 0<B<10], then the target location of the indicator light in the target image is (10, 10).

It can be seen from the above technical solution that the application first determines the target location of the indicator light in the surveillance video by the location mark of the indicator light in the template image, and then analyzes the image information at the target location during the test process to obtain the flashing frequency and duty cycle of the indicator light, thus improving the test efficiency of the indicator light. Then, the electronic device determines a test result of the indicator light by determining whether the flashing frequency of the indicator light satisfies the first condition and determining whether the duty cycle satisfies the second condition. There is no need for manual visual inspection of the indicator lights, thus saving labor costs and further improving the test efficiency of the indicator.

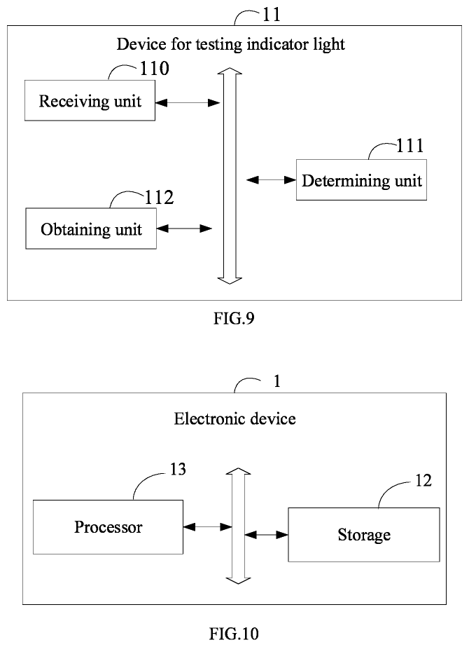

FIG. 9 illustrates a functional module diagram of a device for testing indicator light provided by the present application.

The device 11 for testing indicator light includes a receiving unit 110, a determining unit 111, and an obtaining unit 112. The module/unit referred to in the application refers to a series of computer-readable instruction segments that can be executed by the processor 13 and can complete a fixed function, which are stored in a storage 12. In one embodiment, the functions of each module/unit will be described in detail in subsequent embodiments.

The receiving unit 110 is used to receive surveillance video when the indicator light is working.

The determining unit 111 is used to determine the target position of the indicator light in each frame of the surveillance video according to a pre-stored template image, and the template image includes a location mark of the indicator light in the template image.

The obtaining unit 112 is used to obtain image information of the indicator light at the target location.

The determining unit 111 is also used to determine the flashing frequency and duty cycle of the indicator light according to the image information.

The determining unit 111 is also used to determine the working status of the indicator light according to the flashing frequency and the duty cycle.

In one embodiment, when the target image is any frame image in the surveillance video, the determining unit 111 locates the location of the indicator light in the target image to obtain the target location, including: determining any frame of the image adjacent to the target image in the surveillance video as the test image; determining all pixels in the target image as the first pixels, and determining all pixels in the test image as the second pixels; determining the brightness value of each first pixel, and determining the brightness value of each second pixel; calculating the brightness difference between the first pixel and the second pixel with the same coordinates; when the brightness difference value is greater than the preset threshold, determining the coordinates of the first pixel corresponding to the brightness difference value in the target image as the target position.

In another embodiment, the determining unit 111 locates the position of the indicator light in the target image to obtain the target position, including: determining the pixel value of each first pixel in the target image; when the pixel value is within the preset pixel value range, determining the coordinates of the first pixel corresponding to the pixel value in the target image as the target location.

In one embodiment, the receiving unit 110 obtains the template image, which specifically includes: collecting the target image including the indicator light; locating the location of the indicator light in the target image to obtain the target location; recording the location mark in the target image by the target location to obtain the template image.

In one embodiment, after the receiving unit 110 obtains the template image including the location mark, the determining unit 111 is further configured to: send the template image including the location mark to a terminal that is communicatively connected to the electronic device; receive the position calibration confirmation information sent by the terminal; when the position calibration confirmation information indicates that the calibration has passed, receive the monitoring video of the indicator light when it is working on the electronic equipment.

In one embodiment, the determining unit 111 is further configured to: when the position calibration confirmation information indicates that calibration fails, reposition the indicator light in the target image.

In one embodiment, the determining unit 111 determines the working status of the indicator light according to the flashing frequency and the duty cycle, including: when the flashing frequency satisfies the first condition and the duty cycle satisfies the second condition, determining that the indicator light is in a normal working status. The first condition means that the absolute error between the flashing frequency and the preset flashing frequency does not exceed a preset first difference. The second condition means that the absolute error between the duty cycle and the preset duty cycle does not exceed a preset second difference.

In one embodiment, the duty cycle is a ratio of the length of time that the indicator light is on in the unit time in the surveillance video to the unit time.

It can be seen from the above technical solution that the application first determines the target location of the indicator light in the surveillance video by the location mark of the indicator light in the template image, and then analyzes the image information at the target location during the test process to obtain the flashing frequency and duty cycle of the indicator light, thus improving the test efficiency of the indicator light. Then, the electronic device determines a test result of the indicator light by determining whether the flashing frequency of the indicator light satisfies the first condition and determining whether the duty cycle satisfies the second condition. There is no need for manual visual inspection of the indicator lights, thus saving labor costs and further improving the test efficiency of the indicator.

FIG. 10 illustrate a structural diagram of one embodiment of the method for testing indicator light. The electronic device 1 includes the storage 12 and the processor 13. The storage 12 is used to store computer readable instructions, and the processor 13 is used to execute the computer readable instructions stored in the storage to implement the method for testing indicator light described in any of the above embodiments.

In one embodiment, the electronic device 1 further includes a bus and a computer program stored in the storage 12 and executable on the processor 13, such as a test program for testing indicator light.

FIG. 10 only shows the electronic device 1 with the storage 12 and the processor 13. Those skilled in the art can understand that the structure shown in FIG. 10 does not limit the electronic device 1, and may include fewer or more parts than shown in FIG. 10, or combinations of certain parts, or different parts arrangements.

Combined with FIG. 2, the storage 12 in the electronic device 1 stores multiple computer readable instructions to implement a method for testing indicator light, and the processor 13 can execute the multiple instructions to implement: receiving surveillance video when the indicator light is working on the electronic equipment; determining the target location of the indicator light in each frame of the image in the surveillance video according to the template image, and the template image including the location mark of the indicator light; obtaining image information of the indicator light at the target location according to the location mark; determining the flashing frequency and duty cycle of the indicator light according to the image information; and determining the working status of the indicator light according to the flashing frequency and the duty cycle.

Specifically, for the specific implementation method of the above instructions by the processor 13, reference can be made to the description of the relevant steps in the corresponding embodiment in FIG. 1, which will not be described again here.

Those skilled in the art can understand that the schematic diagram is only an example of the electronic device 1 and does not constitute a limitation on the electronic device 1. The electronic device 1 can be a bus structure or a star structure. The electronic device 1 can also include more or less other hardware or software than shown in the figure, or different component arrangements, for example, the electronic device 1 may also include input and output devices, network access devices, etc.

It should be noted that the electronic device 1 is only an example. If other existing or possible electronic products that may appear in the future can be adapted to the application, they should also be included in the protection scope of the application and be included here by reference.

The storage 12 includes at least one type of readable storage medium, which may be non-volatile or volatile. The readable storage medium includes a flash memory, a mobile hard disk, a multimedia card, a card-type memory (such as SD or DX memory, etc.), a magnetic memory, a magnetic disk, an optical disk, etc. In one embodiment, the storage 12 may be an internal storage unit of the electronic device 1, such as a mobile hard disk of the electronic device 1. In other embodiments, the storage 12 may also be an external storage device of the electronic device 1, such as a plug-in mobile hard disk, a smart memory card (SMC), or a secure digital (SD), a Flash Card, etc. The storage 12 can not only be used to store application software installed on the electronic device 1 and various types of data, such as codes for indicator light test programs, etc., but can also be used to temporarily store data that has been output or is to be output.

In some embodiments, the processor 13 may be composed of an integrated circuit, for example, it may be composed of a single packaged integrated circuit, or it may be composed of multiple integrated circuits packaged with the same function or different functions, including one or more central processing units, microprocessor, digital processing chip, graphics processor and various control chip combinations, etc. The processor 13 is the control core (Control Unit) of the electronic device 1. It uses various interfaces and lines to connect various components of the entire electronic device 1, and runs or executes programs or modules (such as programs of testing indicator light) stored in the storage 12, and call the data stored in the storage 12 to perform various functions of the electronic device 1 and process data.

The processor 13 executes an operating system of the electronic device 1 and various installed application programs. The processor 13 executes the application program to implement the steps in each of the above embodiments of method for testing indicator light t, such as the steps shown in FIG. 2 and FIG. 6-8.

Exemplarily, the computer program may be divided into one or more modules/units, and the one or more modules/units are stored in the storage 12 and executed by the processor 13 to complete the present application. The one or more modules/units may be a series of computer-readable instruction segments capable of completing specific functions. The instruction segments are used to describe the execution process of the computer program in the electronic device 1. For example, the computer program can be divided into a receiving unit 110, a determining unit 111, and an obtaining unit 112.

The above-mentioned integrated units implemented in the form of software function modules can be stored in a computer-readable storage medium. The above-mentioned software function modules are stored in a storage medium and include a number of instructions to cause a computer device (which can be a personal computer, computer device, or network device, etc.) or processor to execute the steps described in various embodiments of the application.

If the integrated modules/units of the electronic device 1 are implemented in the form of software functional units and sold or used as independent products, they can be stored in a computer-readable storage medium. Based on this understanding, the present application can implement all or part of the processes in the methods of the above embodiments, and can also be completed by instructing relevant hardware devices by a computer program. The computer program can be stored in a computer-readable storage medium. The computer program can be stored in a computer-readable storage medium. When the computer program is executed by the processor, the steps of each of the above method embodiments can be implemented.

In one embodiment, the computer program includes computer program code, which may be in the form of source code, object code, executable file or some intermediate form. The computer-readable medium may include: any entity or device capable of carrying the computer program code, recording media, U disk, mobile hard disk, magnetic disk, optical disk, computer memory, read-only memory (ROM), random access memory and other memories, etc.

Further, the computer-readable storage medium may mainly include a storage program area and a storage data area, wherein the storage program area may store an operating system, at least one application program required for a function, etc., the storage data area can store data created based on the use of blockchain nodes, etc.

The bus may be a Peripheral Component Interconnect (PCI) bus or an Extended Industry Standard Architecture (EISA) bus. The bus can be divided into address bus, data bus, control bus, etc. For ease of presentation, only one arrow is used in FIG. 10, but it does not mean that there is only one bus or one type of bus. The bus is configured to enable connection communication between the storage 12 and at least one processor 13 and the like.

Embodiments of the present application also provide a computer-readable storage medium (not shown). Computer-readable instructions are stored in the computer-readable storage medium. The computer-readable instructions are executed by a processor in an electronic device to implement any of the above implementations, such as the method for testing indicator light described in the example.

In the several embodiments provided in the application, it should be understood that the disclosed systems, devices and methods can be implemented in other ways. For example, the device embodiments described above are only illustrative. For example, the division of modules is only a logical function division, and there may be other division methods in actual implementation.

The above description only represents some embodiments of the present application and is not intended to limit the present application, and various modifications and changes can be made to the present application. Any modifications, equivalent substitutions, improvements, etc. made within the spirit and scope of the present application are intended to be included within the scope of the present application.

What is claimed is:

1. A method for testing indicator light comprising:
receiving a surveillance video of an indicator light working on an electronic equipment;
determining a target location of the indicator lights in each frame image of the surveillance video according to a template image, and the template image comprising a location mark of the indicator light;
obtaining image information of the indicator light at the target location according to the location mark;
determining a flashing frequency and a duty cycle of the indicator light according to the image information;
determining a working status of the indicator light according to the flashing frequency and the duty cycle.

2. The method as recited in claim 1, wherein obtaining the template image comprises:
obtaining a target image comprising the indicator light;
locating a location of the indicator light in the target image, and obtaining the target location;
recording the location mark in the target image by the target location, and obtaining the template image.

3. The method as recited in claim 2, wherein locating the location of the indicator light in the target image, and obtaining the target location comprises:
determining any frame image adjacent to the target image in the surveillance video as a test image;
determining all pixels in the target image as first pixels, and determining all pixels in the test image as second pixels;
determining a brightness value of each of the first pixels, and determining a brightness value of each of the second pixels;
calculating a brightness difference between one first pixel and one second pixel with the same coordinates;
in response that the brightness difference is greater than a preset threshold, determining coordinates of the first pixels corresponding to the brightness difference in the target image to be the target location.

4. The method as recited in claim 2, wherein locating the location of the indicator light in the target image, and obtaining the target location comprises:
determining a pixel value of each of the first pixels in the target image;
in response that the pixel value is within a preset pixel value range, determining coordinates of the first pixels corresponding to the pixel value in the target image to be the target location.

5. The method as recited in claim 2, further comprising:
sending the template image comprising the location mark to a terminal communicatively connected to an electronic device;
receiving location calibration confirmation information sent by the terminal;
in response that the location calibration confirmation information is that a calibration is passed, receiving a monitoring video of the indicator light when the indicator light is working on the electronic equipment.

6. The method as recited in claim 5, further comprising:
in response that the location calibration confirmation information indicates that the calibration is failed, repositioning the indicator light in the target image.

7. The method as recited in claim 6, wherein determining the working status of the indicator light according to the flashing frequency and the duty cycle, comprises:
in response that the flashing frequency satisfies the first condition and the duty cycle satisfies a second condition, determining that the indicator light is in a normal working status, and the first condition indicating that an absolute error between the flashing frequency and a preset flashing frequency does not exceed a preset first difference, the second condition indicating that an absolute error between the duty cycle and a preset duty cycle does not exceed a preset second difference.

8. The method as recited in claim 1, wherein the duty cycle is a ratio of a length of time that the indicator light is on per unit time in the surveillance video to a unit time.

9. An electronic device comprising:
a processor; and
a non-transitory storage medium, coupled to the processor, that stores a plurality of instructions, which cause the processor to:
receive a surveillance video of an indicator light working on an electronic equipment;
determine a target location of the indicator light in each frame image of the surveillance video according to a template image, and the template image comprising a location mark of the indicator light;
obtain image information of the indicator light at the target location according to the location mark;
determine a flashing frequency and a duty cycle of the indicator light according to the image information;
determine a working status of the indicator light according to the flashing frequency and the duty cycle.

10. The electronic device as recited in claim 9, wherein the plurality of instructions are further configured to cause the processor to:
obtain a target image comprising the indicator light;
locate a location of the indicator light in the target image, and obtain the target location;
record the location mark in the target image by the target location, and obtain the template image.

11. The electronic device as recited in claim 10, wherein the plurality of instructions are further configured to cause the processor to:
determine any frame image adjacent to the target image in the surveillance video as a test image;
determine all pixels in the target image as first pixels, and determine all pixels in the test image as second pixels;
determine a brightness value of each of the first pixels, and determine a brightness value of each of the second pixels;
calculate a brightness difference between one first pixel and one second pixel with the same coordinates;
in response that the brightness difference is greater than a preset threshold, determine coordinates of the first pixels corresponding to the brightness difference in the target image to be the target location.

12. The electronic device as recited in claim 10, wherein the plurality of instructions are further configured to cause the processor to:
determine a pixel value of each of the first pixels in the target image;
in response that the pixel value is within a preset pixel value range, determine coordinates of the first pixels corresponding to the pixel value in the target image to be the target location.

13. The electronic device as recited in claim 10, wherein the plurality of instructions are further configured to cause the processor to:
send the template image comprising the location mark to a terminal communicatively connected to an electronic device;
receive location calibration confirmation information sent by the terminal;
in response that the location calibration confirmation information is that a calibration is passed, receive a monitoring video of the indicator light when the indicator light is working on the equipment.

14. The electronic device as recited in claim 13, wherein the plurality of instructions are further configured to cause the processor to:
in response that the location calibration confirmation information indicates that the calibration is failed, reposition the indicator light in the target image.

15. The electronic device as recited in claim 14, wherein the plurality of instructions are further configured to cause the processor to:
in response that the flashing frequency satisfies the first condition and the duty cycle satisfies a second condition, determine that the indicator light is in a normal working status, and the first condition indicating that an absolute error between the flashing frequency and a preset flashing frequency does not exceed a preset first difference, the second condition indicating that an absolute error between the duty cycle and a preset duty cycle does not exceed a preset second difference.

16. The electronic device as recited in claim 9, wherein the duty cycle is a ratio of a length of time that the indicator light is on per unit time in the surveillance video to a unit time.

17. A non-transitory storage medium having stored thereon instructions that, when executed by at least one processor of an electronic device, causes the at least one processor to perform a method for testing indicator light, the method comprising:
receiving a surveillance video of an indicator light working on an electronic equipment;
determining a target location of the indicator light in each frame image of the surveillance video according to a template image, and the template image comprising a location mark of the indicator light;
obtaining image information of the indicator light at the target location according to the location mark;
determining a flashing frequency and a duty cycle of the indicator light according to the image information;
determining a working status of the indicator light according to the flashing frequency and the duty cycle.

18. The non-transitory storage medium as recited in claim 17, wherein obtaining the template image comprises:
obtaining a target image comprising the indicator light;
locating a location of the indicator light in the target image, and obtaining the target location;
recording the location mark in the target image by the target location, and obtaining the template image.

19. The non-transitory storage medium as recited in claim 18, wherein locating the location of the indicator light in the target image, and obtaining the target location comprises:
determining any frame image adjacent to the target image in the surveillance video as a test image;
determining all pixels in the target image as first pixels, and determining all pixels in the test image as second pixels;
determining a brightness value of each of the first pixels, and determining a brightness value of each of the second pixels;
calculating a brightness difference between one first pixel and one second pixel with the same coordinates;
in response that the brightness difference is greater than a preset threshold, determining coordinates of the first pixels corresponding to the brightness difference in the target image to be the target location.

20. The non-transitory storage medium as recited in claim 18, wherein locating the location of the indicator light in the target image, and obtaining the target location comprises:
determining a pixel value of each of the first pixels in the target image;
in response that the pixel value is within a preset pixel value range, determining coordinates of the first pixels corresponding to the pixel value in the target image to be the target location.
